(19) United States
(12) Patent Application Publication
(10) Pub. No.: US 2008/0315011 A1
(43) Pub. Date: Dec. 25, 2008

(54) Multiple capillary tubes to dispense vapor

(76) Inventor: Bradley Duane Pesu, Gilbert, AZ (US)

Correspondence Address: Bradley D. Pesu, 3845 E. Edna Dr, Gilbert, AZ, 85296, US

(21) Appl. No.: 11/985,435

(22) Filed: Nov. 13, 2007

Related U.S. Application Data
(60) Provisional application No. 60/858,178, filed on Nov. 13, 2006.

(51) Int. Cl. F24F 6/10; B05B 1/24

(52) U.S. Cl. 239/136; 392/394

(57) ABSTRACT

This invention relates to the use of multiple capillary tubes 10 for the evaporation of volatile active substances, in particular aromatics and/or insecticides from a liquid reservoir 40. The intent is to incorporate individual capillary tubes 20 in a single piece made ideally out of a polymer that can resist both heat and organic compounds. The multiple capillary tubes 10 could replace twisted, braided or woven wicks that are currently used in electronic vapor emanation systems that utilize heat 50 or atomization 60. The multiple capillary tubes 10 are extruded in a single piece and then cut to length or individual capillary tubes are extruded, bundled and then cut to length.

### CROSS REFERENCE TO RELATED APPLICATIONS

This application is based on provisional application Ser. No. 60/858,178, filed on Nov. 13, 2006.

### STATEMENT REGARDING FEDERALLY SPONSORED RESEARCH OR DEVELOPMENT

Not Applicable

### BACKGROUND OF THE INVENTION

1. Field of the Invention

This invention relates generally to the field of a device which dispenses fragrance oil or other liquids which can be volatilized to provide a consumer air care need for the home, office or other areas. Wick based electronic fragrancing has been around for several years and became popular in the late 1990's with the launch of wick based electric diffusers that draws fragrance oil up the wick to a resistor potted in ceramic that is heated using 120 VAC. The potted resistor heats the top area of the wick to release micron size fragrance vapor into a room. These wicks use strands of woven, twisted, or braided fibers that draws up the fragrance oil to the heating area by capillary action. This invention utilizes multiple capillary tubes to volatilize liquid using both heat and atomization.

2. Description of Related Art

U.S. Pat. No. 6,912,355 employs a heating block containing a cylindrical element with a resistive coating that is cut by a laser to adjust the effective resistance. The block has a hole that encircles a wick designed to carry aromatic substances by capillary action. See also U.S. Pat. Nos. 6,501,906 and 6,487,367.

The wick dogs over time causing a difference in fragrance release rate from beginning to end use. The beginning fragrance release rate can be 0.7 grams/day whereas after 40 days use the release can drop to 0.2 grams/day. Not a linear curve.

The wick releases top note fragrance oils first so that the character (smell) of the release is different from the beginning to end.

Wicks tend to dry out when the fragrance level is low in the bottle thus decreasing the fragrance release rate.

The wicks are not in direct contact with the heater thereby reducing effective heat transfer. Convective air heat transfer is less efficient than conductive heat transfer.

Leakage of the volatile liquid can occur if the unit is tipped upside down during operation.

Wicks have also been used with vibrating orifice plates to atomize volatile organic materials.

In U.S. Patent Application Publication 2004/0200907 a wick partially immersed in a fluid extends upwardly from the fluid to a position underneath a vibrating orifice plate. The reference states that the “wick 56 has longitudinally extending capillary passages which draw liquid up from within the container 31 to the upper end of the wick 56.”

Attempts have been made to use a single capillary tube by itself or with wicking material to volatilize liquids using various heating methods.

In U.S. Pat. No. 6,155,268 a capillary tube having a diameter between 0.01 mm and 3 mm is immersed in liquid 34. The upper end of tube 36 is surrounded by an electrical heater 42 to vaporize the liquid that is drawn up 236 by capillary action. This device is apparently used for generating artificial cigarette smoke.

In U.S. Patent Application Publication 200310006302 a capillary tube has its lower end immersed in a fragrance oil. A heater coil can be wound around the outside of the upper end of the tube to evaporate the oil. The reference states that the diameter of the tube is chosen to affect the height the oil is lifted by the capillary action. This reference mentions replacing a capillary tube with a fibrous bundle, that is, a wick. The reference states at Paragraph 18: The capillary principle is not limited to glass tubes. It also applies to a fibrous bundle which also uses surface tension to elevate liquids, like a wick. A fibrous bundle can draw liquids to far greater heights than a single glass tube thereby allowing deeper reservoirs without loss of efficiency when near empty.

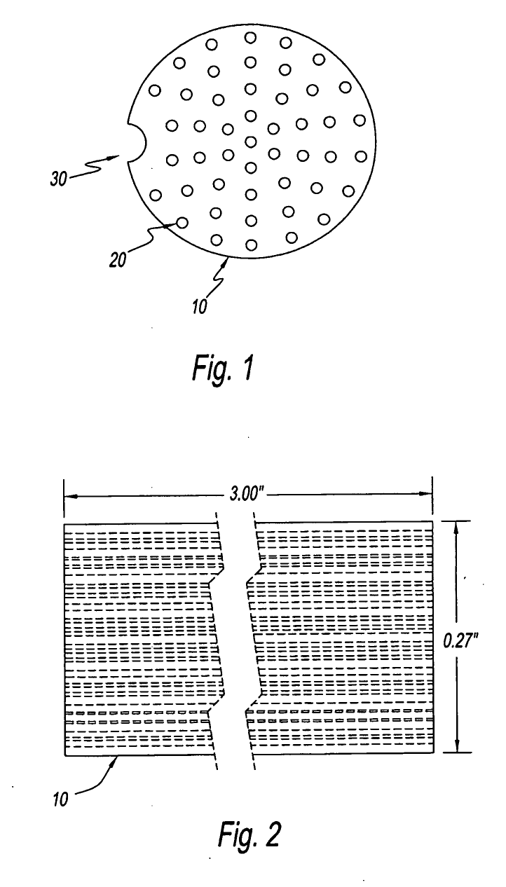

In FIG. 1 of U.S. Patent Application Publication 2005/0155985 a capillary tube 5 extends from the bottom of a vessel containing a liquid fragrance in order to wet the porous material 6 shown resting atop heater 7. In FIG. 2 a wick 30 immersed in the liquid in container 11 extends outside the container next to a heater 7. In Paragraph 29 the reference says a “capillary film may be used in substitution for the wick 30.”

In the aerosol generator of U.S. Pat. No. 5,743,251 liquid is fed into one end of a capillary tube having an inside diameter between 0.05 and 0.53 millimeter. A heater vaporizes the liquid that is then discharged from the opposite end.

Multiple capillary tubes will be able to volatilize more liquid into vapor than single capillary tubes used in prior art.

### SUMMARY OF THE INVENTION

The primary object of the invention is to use multiple capillary tubes is to replace a woven, twisted or braided wick while utilizing new or existing electric diffuser fragrance bulbs, heaters and atomizers. Note that a capillary tube by definition is different than a wick but both provide capillary action.

Another object of the invention is multiple capillary tubes can provide more linear fragrance release than woven, twisted or braided wicks.

Another object of the invention is the character (smell) of the fragrance release should be consistent from beginning to end since the liquid fragrance oil is drawn from the bottom of the liquid container.

A further object of the invention is there is little to no leakage if the liquid container is tipped upside down using properly designed multiple capillary tubes.

Yet another object of the invention is fragrance release can be adjusted by making smaller or larger ID capillary tubes in an extrusion process.

Still yet another object of the invention is the extrusion process can be set-up to produce a single piece made ideally out of a polymer but which incorporates the multiple small ID capillary tubes.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, multiple capillary tubes can be incorporated in a single piece through extrusion and then cut to length.

This finished piece can then be inserted into a container which holds a liquid to be volatilized. The liquid will flow to the top of the capillary tubes.

Heat surrounding the top outside diameter surface of the multiple capillary tube piece can be used to volatilize the liquid from the capillary tubes to the outside air.

A vibratable orifice plate positioned on the top of the multiple capillary tube piece could also be used to volatilize the liquid to the outside air.

These and other aspects, objects, features and advantages of the present invention will be more clearly understood and appreciated from a review of the following detailed description of the preferred embodiments, and by reference to the accompanying drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> is a plan view of the invention showing a side vent hole and in a preferred embodiment multiple capillary tubes.

FIG. <2> is a cross sectional view of the invention showing multiple capillary tubes inside the solid extruded piece.

FIG. <3> is an elevational view of the invention showing multiple capillary tubes in a solid extruded piece.

FIG. <4> is an elevational view of the invention showing the solid extruded piece which has multiple capillary tubes inserted inside a liquid reservoir which can hold a liquid to be volatilized.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning first to FIG. 1, the top of the multiple capillary tube piece 10 shows forty seven individual 0.010″ ID capillary tubes 20 incorporated in a single extruded piece. Testing has shown that a capillary tube ID of 0.010″ is ideal for raising liquid to the top of the multiple capillary tube piece 10 but other IDs could be used depending on the surface tension of the capillary piece and that of the liquid being transported up the individual capillary tubes. Testing has also shown that the liquid stays at the top of the capillary tubes in use and does not spill over. Heat from an electronic source can be applied around the top outside diameter surface of the multiple capillary tube piece 10 to volatilize the liquid into the air. It is ideal to have no air gap between the heater and the multiple capillary tube piece 10 so lower heater surface temperatures can be used. An electronic vibratable orifice plate could also be placed on top of the multiple capillary tube piece 10 to atomize the liquid into the air.

The multiple capillary tube piece 10 would be made out of a polymer that can resist fragrance oil and heat degradation. Nylon is a good choice for this although metal, ceramic or glass could also be used. It has been found that extrusion is the best process to produce this item. Bundling of individual capillary tubes could also be used.

Also shown in FIG. 1 is a side vent hole 30 with a radius of 0.020″. This side vent hole serves 2 purposes. This first is to allow the device to draw the liquid up the individual capillary tubes 20. If there was no venting then the piece would not draw liquid up the capillary tubes. Note that a side vent hole is not needed if the liquid reservoir already provides venting with the multiple capillary tube piece 10 inserted into the liquid reservoir 40. The second purpose of the side vent hole 30 is to prevent leakage if the multiple capillary tube piece is accidentally upside down during use. The intent is to insert the multiple capillary tube piece 10 in a liquid reservoir 40 using a friction fit. The liquid reservoir 40 would not need to have any venting holes. Testing has shown that no leakage occurs if this assembly is upside down. Some wick based electronic fragrancing systems leak liquid when upside down during use thus causing damage to the surrounding environment.

FIG. 2 shows a side cross sectional view of the extruded multiple capillary tube piece 10. The outside diameter and length dimensions shown are ideal for this application but other length dimensions could be used depending on the surface tension of the material used to make the multiple capillary tube piece 10 and the surface tension of the liquid being transported in the capillary tubes. The extrusion process to produce this piece has flexibility to change the outside diameter of the piece and you can cut to any length desired to fit the dimensions of the liquid reservoir 40. An extruder like Precision Extrusion of Glens Falls, N.Y. is skilled in the art of capillary tube manufacturing.

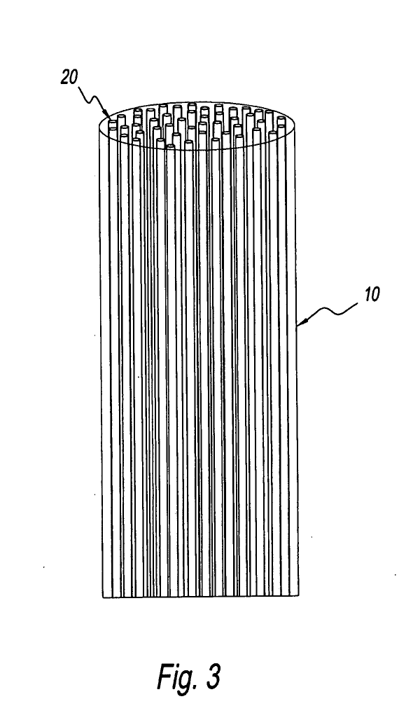

FIG. 3 shows an elevational view of the extruded multiple capillary tube piece 10. Also shown are individual capillary tubes 20.

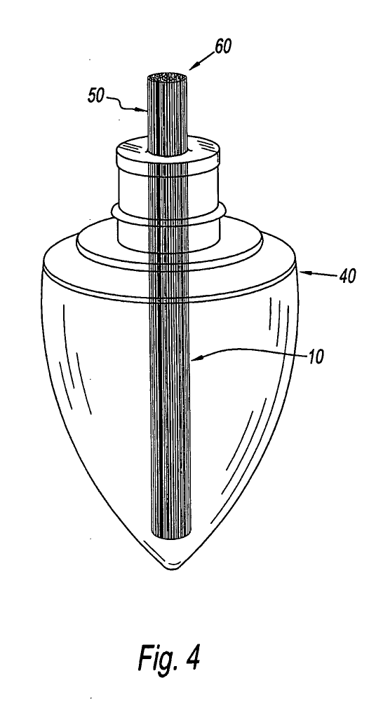

FIG. 4 shows an elevational view of the extruded multiple capillary tube piece 10 inserted into a liquid reservoir 40. Also shown is a heating area 50 which encircles the outside diameter of the extruded multiple capillary tube piece to volatilizes liquid out of the top of the multiple capillary tube piece. The heating area 50 is known in the prior art 6,501,906 for wick based electronic fragrance release systems. Wick based fragrance systems do no provide linear fragrance release. Fragrance oil and a solvent carrier have been tested in this application but other chemical mixtures are being evaluated to optimize the fragrance release rate.

FIG. 4 also shows an atomizing location 60 where an electronic vibratable orifice plate could be placed on the top of the multiple capillary tube piece 10 to atomize the liquid into the air. Electronic atomizer wicking systems are known in the prior art 7,017,829. The fragrance release of these atomizer wicking systems is linear but the amount of fragrance release is low compared to candles and wick based electronic fragrance release systems. The multiple capillary tube piece could provide a much greater amount of fragrance release in this application.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims

What is claimed is:

1. An electronic vapor dispensing device comprising: a liquid reservoir, multiple capillary tubes inserted into said reservoir and protruding from the reservoir, for vapor release from the multiple capillary tubes by a heating source or atomization of the liquid in the protruding area above the reservoir.

2. The device of claim 1, where the number of capillary tubes is a minimum of 2.

3. The device of claim 1, where the inside diameter of the capillary tubes is a minimum of 0.002″.

4. The device of claim 1, where the multiple capillary tubes are extruded and then cut in a single piece.

5. The device of claim 1, where individual capillary tubes are extruded, bundled and then cut in a single multiple capillary tube piece.

6. The device of claim 1, where the material used to make a multiple capillary tube piece is a polymer, metal, ceramic or glass.

7. The device of claim 4, where a vent hole runs longitudinally on the outside of the single piece.

8. The device of claim 7, where the radius of the vent hole is a minimum of 0.002″.

9. The device of claim 1, where heat from an electronic source can be applied to the protruding outside diameter surface of the multiple capillary tube piece to volatilize the liquid into the air from the capillary tube openings.

10. The device of claim 1, where an electronic vibratable orifice plate can be applied to the protruding top surface of the multiple capillary tube piece to atomize the liquid into the air from the capillary tube openings.
